(19) United States
(12) Patent Application Publication
(10) Pub. No.: US 2014/0226257 A1
(43) Pub. Date: Aug. 14, 2014

(54) CAPACITOR AND METHOD OF MANUFACTURING CAPACITOR

(71) Applicant: TAIYO YUDEN CO., LTD., Tokyo (JP)

(72) Inventors: Yoshinari TAKE, Tokyo (JP); Hidetoshi MASUDA, Tokyo (JP)

(73) Assignee: TAIYO YUDEN CO., LTD., Tokyo (JP)

(21) Appl. No.: 14/164,747

(22) Filed: Jan. 27, 2014

(30) Foreign Application Priority Data
Feb. 8, 2013 (JP) 2013-023272

(51) Int. Cl. H01G 4/005

(52) U.S. Cl. CPC H01G 4/005
USPC 361/303

(57) ABSTRACT

A capacitor according to the present invention includes a dielectric layer, a first external electrode layer, a second external electrode layer, a first internal electrode, and a second internal electrode. The dielectric layer is formed of a metal oxide having a crystalline structure and includes a first surface, a second surface on the opposite side to the first surface, and a plurality of through holes communicating with the first surface and the second surface. The first external electrode layer is disposed on the first surface. The second external electrode layer is disposed on the second surface. The first internal electrode is formed in through holes, and is connected to the first external electrode layer. The second internal electrode is formed in the through holes, and is connected to the second external electrode layer.

### CROSS-REFERENCE TO RELATED APPLICATIONS

This application is based on and claims the benefit of priority from Japanese Patent Application Serial No. 2013-023272 (filed on Feb. 8, 2013), the contents of which are hereby incorporated by reference in their entirety.

### FIELD OF THE INVENTION

The present invention relates to a porous capacitor.

### BACKGROUND

In recent years, porous capacitors have been developed as a new type of capacitor. The porous capacitor is configured such that an internal electrode is formed within pores using a property that a metal oxide formed on a surface of a metal, such as aluminum, forms a porous (a through hole of a micropore) structure and that the metal oxide is used as a dielectric body to form a capacitor.

An external conductor is laminated on each of a surface and a rear surface of the dielectric body, and the internal electrode formed within the pores is connected to any one of the external conductor of the surface and the external conductor of the rear surface. The internal electrode and the external conductor which is not connected to the internal electrode are insulated from each other by a void or an insulating material. Thus, the internal electrodes function as counter electrodes (positive electrode or negative electrode) which face each other with the dielectric body interposed therebetween.

For example, Japanese Patent No. 4493686 and Japanese Unexamined Patent Application Publication No. 2009-76850 disclose a porous capacitor having such a configuration. In either one of them, an internal electrode is formed within pores, one end of the internal electrode is connected to one conductor, and the other end is insulated from the other conductor.

As described above, in the porous capacitor, the internal electrodes formed within the pores are configured to face each other with the dielectric body interposed therebetween, but the dielectric body is formed of a metal oxide and does not have a dense structure. For this reason, there is a problem that variations in withstand voltage characteristics of the dielectric body located between the internal electrodes occur.

### SUMMARY

The present invention is contrived in view of such situations, and an object thereof is to provide a porous capacitor having excellent withstand voltage characteristics and a manufacturing method thereof.

In order to accomplish the object, a capacitor according to an embodiment of the present invention includes a dielectric layer, a first external electrode layer, a second external electrode layer, a first internal electrode, and a second internal electrode.

The dielectric layer is formed of a metal oxide having a crystalline structure, and includes a first surface, a second surface on the opposite side to the first surface, and a plurality of through holes communicating with the first surface and the second surface.

The first external electrode layer is disposed on the first surface.

The second external electrode layer is disposed on the second surface.

The first internal electrode is formed in the plurality of through holes and is connected to the first external electrode layer.

The second internal electrode is formed in the plurality of through holes and is connected to the second external electrode layer.

### BRIEF DESCRIPTION OF THE DRAWINGS

FIG. 1 is a perspective view of a capacitor according to an embodiment of the present invention.

FIG. 2 is a cross-sectional view of the capacitor.

FIG. 3 is a perspective view of a dielectric layer of the capacitor.

FIG. 4 is a cross-sectional view of the dielectric layer of the capacitor.

FIG. 5 illustrates XRD measurement results of a metal oxide serving as the dielectric layer of the capacitor.

FIG. 6 illustrates results of a withstand voltage test of the capacitor.

FIGS. 7a to 7c are schematic diagrams illustrating a manufacturing process of the capacitor.

FIGS. 8a to 8c are schematic diagrams illustrating a manufacturing process of the capacitor.

FIGS. 9a to 9c are schematic diagrams illustrating a manufacturing process of the capacitor.

FIGS. 10a to 10c are schematic diagrams illustrating a manufacturing process of the capacitor.

FIGS. 11a to 11c are schematic diagrams illustrating a manufacturing process of the capacitor.

FIGS. 12a to 12b are schematic diagrams illustrating a manufacturing process of the capacitor.

FIG. 13 is a cross-sectional view illustrating an array of through holes in the dielectric layer of the capacitor.

FIG. 14 is a cross-sectional view illustrating an array of through holes in the dielectric layer of the capacitor.

FIG. 15 is a cross-sectional view illustrating an array of through holes in the dielectric layer of the capacitor.

FIG. 16 is a cross-sectional view illustrating an array of through holes in the dielectric layer of the capacitor.

FIG. 17 is a cross-sectional view illustrating an array of through holes in the dielectric layer of the capacitor.

FIG. 18 is a cross-sectional view illustrating an array of through holes in the dielectric layer of the capacitor.

FIG. 19 is a cross-sectional view illustrating an array of through holes in the dielectric layer of the capacitor.

### DESCRIPTION OF THE PREFERRED EMBODIMENTS

A capacitor according to an embodiment of the present invention may include a dielectric layer, a first external electrode layer, a second external electrode layer, a first internal electrode, and a second internal electrode.

The dielectric layer may be formed of a metal oxide having a crystalline structure, and may include a first surface, a second surface on the opposite side to the first surface, and a plurality of through holes communicating with the first surface and the second surface.

The first external electrode layer may be disposed on the first surface.

The second external electrode layer may be disposed on the second surface.

The first internal electrode may be formed in the plurality of through holes, and may be connected to the first external electrode layer.

The second internal electrode may be formed in the plurality of through holes, and may be connected to the second external electrode layer.

According to this configuration, the first internal electrode and the second internal electrode may face each other with the dielectric layer, formed of a metal oxide having a crystalline structure, interposed therebetween. Since the metal oxide having a crystalline structure is denser than a metal oxide which does not have a crystalline structure (that is, which has an amorphous structure), variations in withstand voltage characteristics may not occur between the first internal electrode and the second internal electrode, and thus it may be possible to improve withstand voltage characteristics of the capacitor. Meanwhile, the metal oxide having a crystalline structure may include a metal oxide constituted by only a crystalline structure and a metal oxide having a crystalline structure in an amorphous (noncrystalline) structure.

The dielectric layer may be formed of a material that generates through holes by an anodization action.

According to this configuration, it may be possible to form a dielectric layer having through holes by an anodization process and to manufacture a capacitor having the above-described structure.

The dielectric layer may be formed of an aluminum oxide.

An aluminum oxide generated by anodizing aluminum generates through holes by a self-organizing action in the process of oxidation. That is, it may be possible to form a dielectric layer having through holes by anodizing of aluminum.

The dielectric layer may be formed of an aluminum oxide having at least any one crystalline phase of an α phase, a θ phase, a δ phase, and a γ phase.

The aluminum oxide may have a crystalline phase of an α phase, a θ phase, a δ phase, and a γ phase depending on crystallization conditions. That is, it may be possible to use an aluminum oxide having at least any one crystalline phase of an α phase, a θ phase, a δ phase, and a γ phase, as a metal oxide having a crystalline structure.

A method of manufacturing a capacitor according to an embodiment of the present invention may be used to form a metal oxide having a plurality of through holes by oxidizing a metal.

The metal oxide may be heated to be crystallized.

The first internal electrode and the second internal electrode may be formed in the plurality of through holes.

The first external electrode layer connected to the first internal electrode and the second external electrode layer connected to the second internal electrode may be disposed on the metal oxide.

According to this manufacturing method, it may be possible to manufacture a capacitor having a dielectric layer formed of a metal oxide having a crystalline structure. Meanwhile, in the process of crystallizing the metal oxide, the entire metal oxide may be crystallized, or the metal oxide may be partially crystallized.

The metal oxide may be an aluminum oxide. In the process of crystallizing the metal oxide, the aluminum oxide may be heated to a temperature of equal to or higher than 800° C.

When the aluminum oxide is heated to a temperature of equal to or higher than 800° C., a crystalline phase may be generated. That is, according to this manufacturing method, it may be possible to manufacture a capacitor having a dielectric layer formed of an aluminum oxide having a crystalline structure.

Hereinafter, embodiments of the present invention will be described with reference to the accompanying drawings.

### [Configuration of Capacitor]

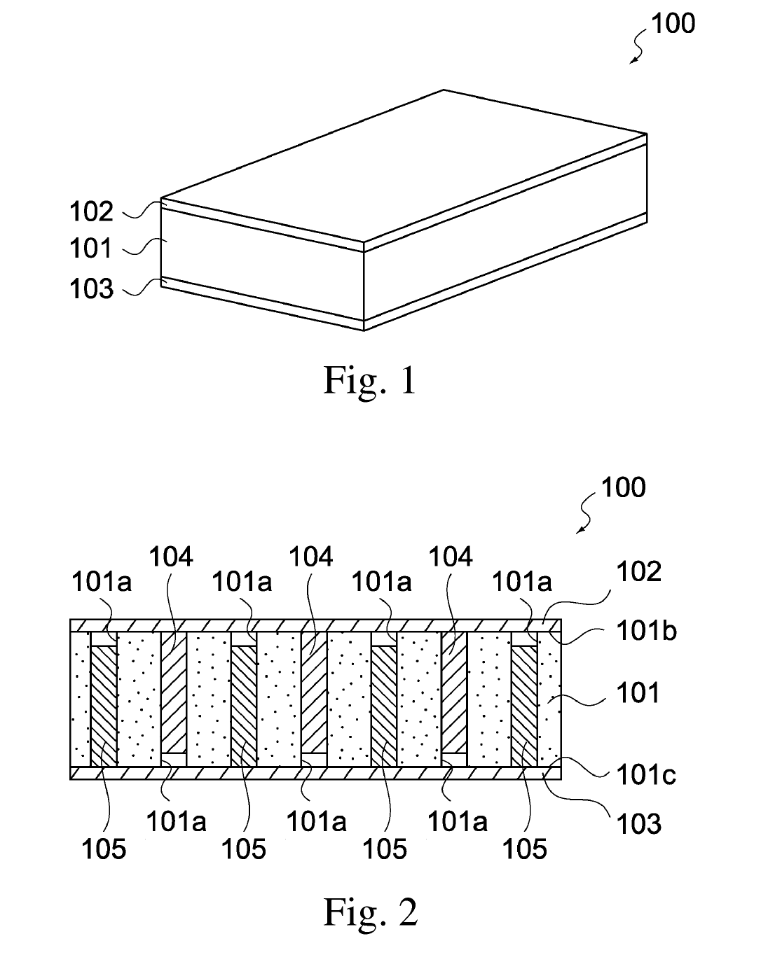

FIG. 1 is a perspective view of a capacitor 100 according to an embodiment of the present invention, and FIG. 2 is a cross-sectional view of the capacitor 100. As illustrated in FIGS. 1 and 2, the capacitor 100 may include a dielectric layer 101, a first external electrode layer 102, a second external electrode layer 103, a first internal electrode 104, and a second internal electrode 105.

The first external electrode layer 102, the dielectric layer 101, and the second external electrode layer 103 may be laminated in this order. That is, the dielectric layer 101 may be sandwiched between the first external electrode layer 102 and the second external electrode layer 103. As illustrated in FIG. 2, the first internal electrode 104 and the second internal electrode 105 may be formed inside through holes 101a formed in the dielectric layer 101. Meanwhile, the capacitor 100 may be provided with a component other than the components illustrated herein, for example, a wiring connected to each of the first external electrode layer 102 and the second external electrode layer 103.

The dielectric layer 101 may be a layer functioning as a dielectric body of the capacitor 100. The dielectric layer 101 may be formed of a metal oxide having a crystalline structure. The “metal oxide having a crystalline structure” may include a metal oxide constituted by only a crystalline structure, and a metal oxide having a crystalline structure within an amorphous structure. It may be possible to confirm the presence or absence of a crystalline structure in the metal oxide by an analysis of a crystalline structure which will be described later.

In addition, the metal oxide constituting the dielectric layer 101 may be a material capable of forming through holes (pores) which will be described later. In particular, a material generating pores by a self-organizing action when being anodized may be suitable. An example of such a material may include an aluminum oxide (Al₂O₃). In addition to this, the dielectric layer 101 can also be formed of an oxide of a valve metal (Al, Ta, Nb, Ti, Zr, Hf, Zn, W, or Sb).

Examples of a crystalline structure of an aluminum oxide may include a γ phase, a δ phase, a θ phase, and an α phase. That is, more specifically, the “metal oxide having a crystalline structure” can be an aluminum oxide having at least any one crystalline phase of a γ phase, a δ phase, a θ phase, and an α phase. Even when the dielectric layer 101 is formed of any of other metal oxides, the dielectric layer 101 can also be formed of a metal oxide having an allowable crystalline structure for the metal oxide.

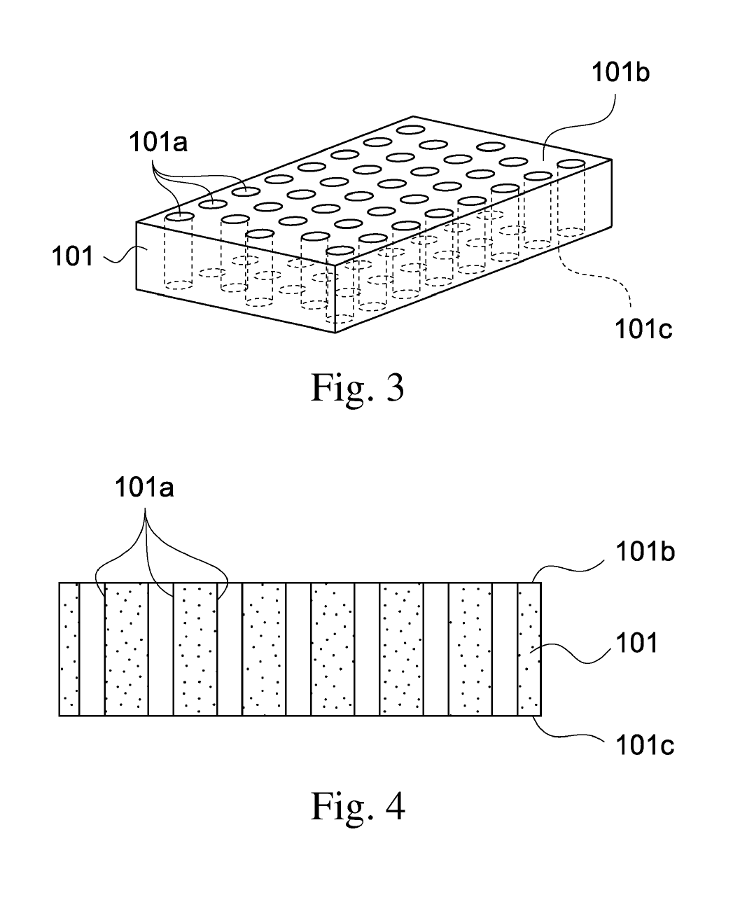

Although the thickness of the dielectric layer 101 is not particularly limited, the thickness can be set to, for example, several μm to several hundreds of μm. FIG. 3 is a perspective view of the dielectric layer 101, and FIG. 4 is a cross-sectional view of the dielectric layer 101. As illustrated in these drawings, the plurality of through holes 101a may be formed in the dielectric layer 101. When a surface of the dielectric layer 101 which is parallel to a planar direction is set to a first surface 101b and a surface on the opposite side thereto is set to a second surface 101c, the through holes 101a may be formed along a direction perpendicular to the first surface 101b and the second surface 101c (the thickness direction of the dielectric layer 101), and may be formed so as to communicate with the first surface 101b and the second surface 101c. Meanwhile, the number and size of through holes 101a illustrated in FIG. 3 and the like are for the purpose of convenience, and a real through hole may be smaller in size and larger in number.

As illustrated in FIG. 2, the first external electrode layer 102 may be disposed on the first surface 101b of the dielectric layer 101. The first external electrode layer 102 can be formed of a conductive material, for example, a pure metal such as Cu, Ni, Cr, Ag, Pd, Fe, Sn, Pb, Pt, Ir, Rh, Ru, Al, or Ti, or an alloy thereof. The thickness of the first external electrode layer 102 can be set to, for example, several tens of nm to several μm. In addition, the first external electrode layer 102 can also be disposed in such a manner that multiple layers of conductive materials are laminated.

As illustrated in FIG. 2, the second external electrode layer 103 may be disposed on the second surface 101c of the dielectric layer 101. The second external electrode layer 103 can be formed of a conductive material similar to that of the first external electrode layer 102, and the thickness thereof can be set to, for example, several nm to several μm. The constituent material of the second external electrode layer 103 may be the same as or different from the constituent material of the first external electrode layer 102. In addition, the second external electrode layer 103 can be disposed in such a manner that multiple layers of conductive materials are laminated.

The first internal electrode 104 may function as one counter electrode of the capacitor 100. The first internal electrode 104 can be formed of a conductive material, for example, a pure metal such as In, Sn, Pb, Cd, Bi, Al, Cu, Ni, Au, Ag, Pt, Pd, Co, Cr, Fe, or Zn, or an alloy thereof. As illustrated in FIG. 2, the first internal electrode 104 may be formed within the through holes 101a and may be connected to the first external electrode layer 102. In addition, the first internal electrode 104 may be formed so as to be separated from the second external electrode layer 103, and may be insulated from the second external electrode layer 103. An insulator (not shown) may be filled in a gap between the first internal electrode 104 and the second external electrode layer 103.

The second internal electrode 105 may function as the other counter electrode of the capacitor 100. The second internal electrode 105 can be formed of a conductive material similar to that of the first internal electrode 104. A material of the second internal electrode 105 may be the same as or different from that of the first internal electrode 104. As illustrated in FIG. 2, the second internal electrode 105 may be formed within the through holes 101a, and may be connected to the second external electrode layer 103. In addition, the second internal electrode 105 may be formed so as to be separated from the first external electrode layer 102, and may be insulated from the first external electrode layer 102. An insulator (not shown) may be filled in a gap between the second internal electrode 105 and the first external electrode layer 102.

Meanwhile, the first internal electrode 104 and the second internal electrode 105 which are illustrated in FIG. 2 and the like are illustrated alternating with each other, but these electrodes are for the purpose of convenience, and may not be present alternately in reality.

The capacitor 100 has the above-described configuration. The first internal electrode 104 and the second internal electrode 105 may face each other with the dielectric layer 101 interposed therebetween to form a capacitor. That is, the first internal electrode 104 and the second internal electrode 105 may function as counter electrodes (positive electrode or negative electrode) of the capacitor. Meanwhile, either one of the first internal electrode 104 and the second internal electrode 105 may be a positive electrode. The first internal electrode 104 may be connected to an external wiring or terminal with the first external electrode layer 102 interposed therebetween, and the second internal electrode 105 may be connected thereto with the second external electrode layer 103 interposed therebetween.

[With regard to Crystalline Structure of Metal Oxide]

As described above, the dielectric layer 101 of the capacitor 100 may be formed of a metal oxide having a crystalline structure. It may be possible to confirm whether the metal oxide has a crystalline structure by a crystalline structure analysis such as X-ray diffraction (XRD).

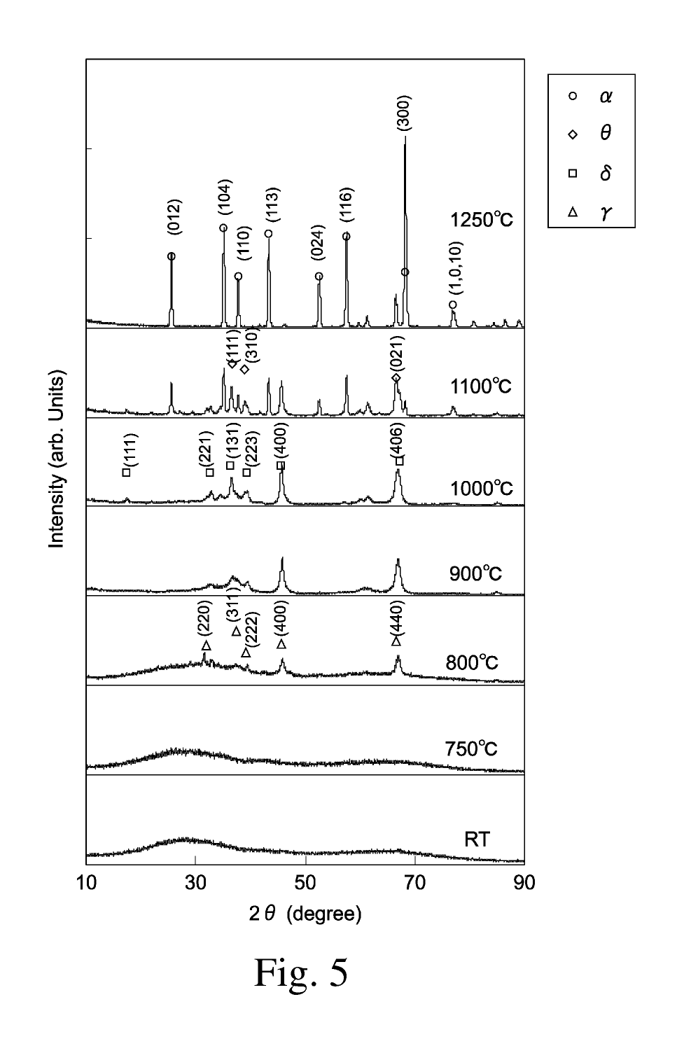

FIG. 5 shows XRD measurement results of an aluminum oxide. The measurement results shown in FIG. 5 are obtained by measuring an aluminum oxide (bulk), as a measurement sample, which is held for four hours at any one temperature of 750° C., 800° C., 900° C., 1000° C., 1100° C., and 1250° C. The measurement samples can be lined up on a sample stage so that surfaces of samples to be measured are located on the same level. In addition, the measurement sample may be ground into a powder using a mortar, and then measurement surfaces may be arranged to be set on the sample stage. A measuring apparatus used for the measurement is an X'pert MRD (manufactured by PANalytical Co., Ltd), and measurement conditions are as follows: measurement range (2θ) of 10° to 90°, tube voltage of 45 kV, tube current of 40 my, anticathode of Cu, use of a monochromator, and scanning step of 0.01°.

FIG. 5 shows peaks identified with an α phase, a θ phase, a δ phase or a γ phase and Miller indexes. In a sample heated to a temperature of 750° C., a noticeable peak is not shown similar to a non-heated (RT) sample, and it may be seen that an aluminum oxide has an amorphous structure. In the sample heated to a temperature of equal to or higher than 800° C., a peak derived from the γ phase can be confirmed. Furthermore, as the heating temperature increases, peaks derived from the δ phase and the θ phase are shown. In the sample heated to a temperature of 1250° C., only a peak derived from the α phase is shown.

In this manner, the aluminum oxide can be heated to a temperature of equal to or higher than 800° C. to generate a crystalline structure, and the presence or absence of a crystalline structure can be confirmed by XRD. In addition, similarly, other metal oxides may be heated to a temperature of equal to or higher than a predetermined temperature to generate a crystalline structure. The presence or absence of a crystalline structure in the metal oxide can be macroscopically or locally confirmed not only by XRD but also by electron energy-loss spectroscopy (EELS) or other analysis methods.

### [Effects of Capacitor]

The capacitor 100 having the above-described configuration may have the following effects. As illustrated in FIG. 2, the first internal electrode 104 and the second internal electrode 105 may face each other with the dielectric layer 101 interposed therebetween. For this reason, when a voltage is applied between the first internal electrode 104 and the second internal electrode 105, withstand voltage characteristics of the dielectric layer 101 located therebetween may become a problem.

If the dielectric layer 101 is a metal oxide which does not have a crystalline structure (that is, which has an amorphous structure), a portion which is not dense is present in the structure, and thus a variation in withstand voltage characteristics may occur. However, as described above, when the dielectric layer 101 is formed of a metal oxide having a crystalline structure, a variation in withstand voltage characteristics may not occur due to a dense crystalline structure. That is, it may be possible to use a capacitor having high withstand voltage characteristics as the capacitor 100.

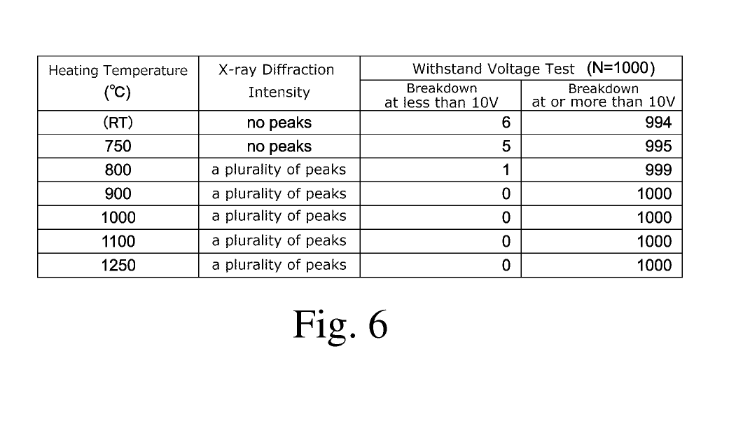

FIG. 6 is a table showing results of a withstand voltage test of a capacitor. In this test, a metal oxide (aluminum oxide) which is heated at each of temperatures described in the table was used as a dielectric layer. As for the rest, 1000 capacitors having the above-described configuration (see FIG. 2) were created, and an applied voltage at which dielectric breakdown occurs was measured Meanwhile, the capacitor can be created by a manufacturing method to be described later.

The applied voltage was increased by 0.5 V, and the capacitor not causing dielectric breakdown for 10 seconds was determined to be a capacitor in which dielectric breakdown did not occur at the same applied voltage. As illustrated in FIG. 6, when heating was not performed (RT) or when a heating temperature was low, dielectric breakdown of a capacitor occurred at an applied voltage less than 10 V. On the other hand, when the heating temperature was high, a capacitor causing dielectric breakdown at an applied voltage less than 10 V was not shown.

From these results, it can be said that a metal oxide is heated to crystallize the metal oxide and that withstand voltage characteristics of the capacitor are improved. In addition, when the metal oxide is an aluminum oxide, it can be said that a heating temperature is preferably equal to or higher than 800° C. and is more preferably equal to or higher than 900° C.

### [Method of Manufacturing Capacitor]

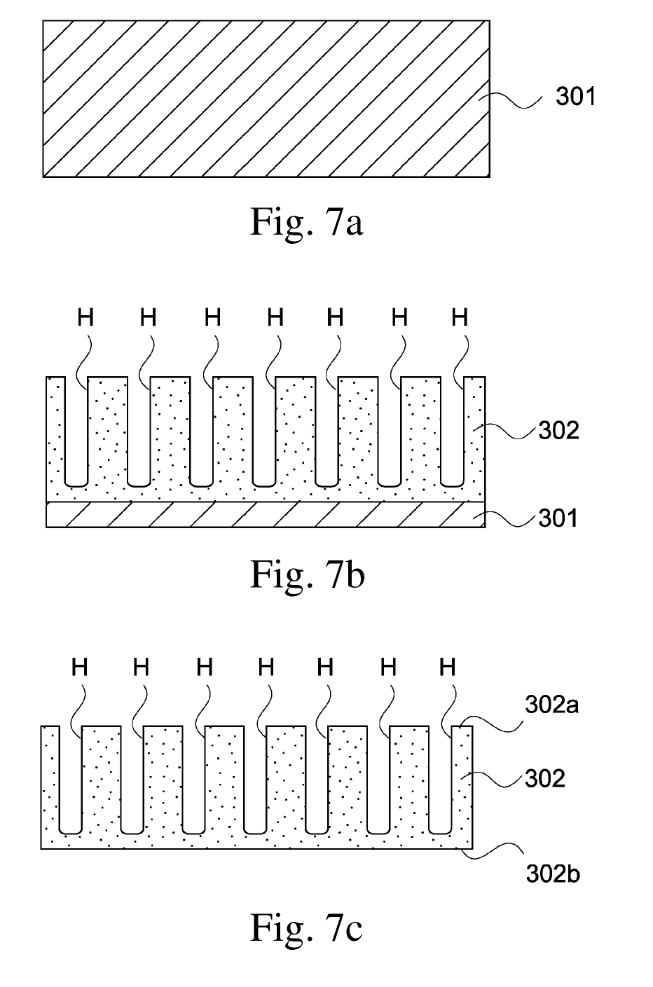

A method of manufacturing the capacitor 100 according to this embodiment will be described. Meanwhile, the manufacturing method described below may be an example, and it may be possible to manufacture the capacitor 100 by a manufacturing method different from the manufacturing method described below. FIGS. 7 to 12 are schematic diagrams illustrating a manufacturing process of the capacitor 100.

FIG. 7a illustrates a first substrate 301 serving as a base of the dielectric layer 101. The first substrate 301 may be a metal before the metal oxide serving as the dielectric layer 101 is oxidized. When the metal oxide is an aluminum oxide, the first substrate 301 may be aluminum.

For example, when a voltage is applied to an oxalic acid (0.1 mol/l) solution which is adjusted to a temperature of 15° C. to 20° C. by using the first substrate 301 as an anode, the first substrate 301 may be oxidized (anodized) as illustrated in FIG. 7b, and thus a metal oxide 302 may be formed. At this time, holes H may be formed in the metal oxide 302 by a self-organizing action of the metal oxide 302. The holes H may grow toward a progressing direction of the oxidation, that is, the thickness direction of the first substrate 301.

Meanwhile, regular pits (concave portions) may be formed in the first substrate 301 before the anodization, and the holes H may be grown with the pits as starting points. The array of the holes H can be controlled by the arrangement of the pits. For example, the pits can be formed by pressing a mold (cast) on the first substrate 301.

Subsequently, as illustrated in FIG. 7c, the first substrate 301 which is not oxidized may be removed. The removal of the first substrate 301 can be performed by, for example, wet etching. Then, a surface on the side where the holes H of the metal oxide 302 are formed may be set to a surface 302a, and a surface on the opposite side thereto may be set to a rear surface 302b.

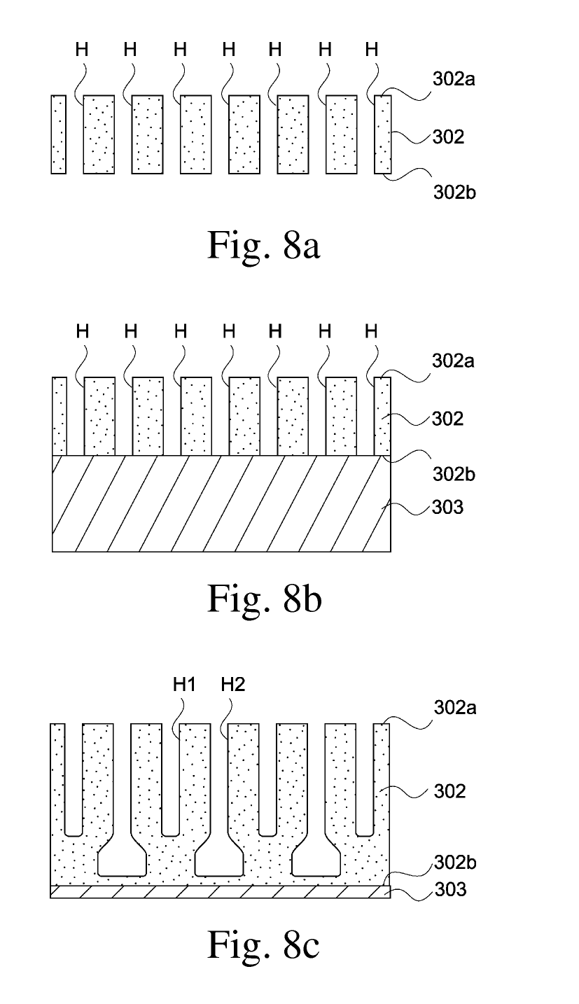

Subsequently, as illustrated in FIG. 8a, the metal oxide 302 may be removed by a predetermined thickness from the rear surface 302b side. The removal of the metal oxide can be performed by reactive ion etching (RIE). At this time, the metal oxide 302 may be removed by a thickness to such an extent that the holes H communicate with the rear surface 302b.

Subsequently, the metal oxide 302 may be crystallized. The metal oxide 302 can be heated in the air to be crystallized, and can be heated using, for example, an electric furnace. When the metal oxide 302 is an aluminum oxide, as described above, a heating temperature can be set to a temperature equal to or higher than 800° C. to be crystallized. However, the heating temperature of equal to or higher than 900° C. may further promote crystallization, which results in preferable results. A heating time can be set to, for example, four hours.

Subsequently, as illustrated in FIG. 8b, a second substrate 303 may be disposed on the rear surface 302b of the metal oxide 302. For example, the second substrate 303 can be disposed by a sputtering method. Similarly to the first substrate 301, the second substrate 303 can be formed of a metal before the metal oxide serving as the dielectric layer 101 is oxidized When the metal oxide is an aluminum oxide, the second substrate 303 may be aluminum.

Subsequently, for example, when a voltage is applied to an oxalic acid (0.1 mol/l) solution which is adjusted to a temperature of 15° C. to 20° C. by using the second substrate 303 as an anode, the second substrate 303 may be oxidized (anodized) as illustrated in FIG. 8c. At this time, the applied voltage may be increased further than when the holes H are formed. Since a pitch of the holes H formed by self-organization is determined depending on the magnitude of the applied voltage, the self-organization may progress so that the pitch of the holes H is enlarged. Thus, as illustrated in FIG. 8c, the formation of the holes may be continued with respect to some holes H, and the hole diameter may be enlarged. On the other hand, the formation of the holes may be stopped with respect to other holes H by the pitch of the holes H being enlarged. Hereinafter, the holes H in which the formation of the holes is stopped may be set to a hole H1, and the holes H in which the formation of the holes is continued (the hole diameter is enlarged) may be set to a hole H2.

Conditions of the anodization can be appropriately set. For example, an applied voltage of a first stage of anodization illustrated in FIG. 7b may be set to several V to several hundreds of V, and a processing time may be set to several minutes to several days. In an applied voltage of a second stage of anodization illustrated in FIG. 8c, a voltage value may be set to several times that in the first stage of anodization, and a processing time may be set to several minutes to several tens of minutes.

For example, the first stage of applied voltage may be set to 40 V, and thus the holes H having a diameter of 100 nm may be formed In addition, the second stage of applied voltage may be set to 80 V, and thus the diameter of the holes H2 may be enlarged to 200 nm. The second stage of voltage value may be set to be in the above-described range, and thus the number of holes H1 and the number of holes H2 can be set to be substantially equal to each other. In addition, the processing time of the second stage of voltage application may be set to be in the above-described range, and thus the pitch conversion of the holes H2 may be sufficiently completed, and it may be possible to reduce the thickness of the metal oxide 302 formed in the bottom by the second stage of voltage application. Since the metal oxide 302 formed by the second stage of voltage application is removed in a later process, the metal oxide may be preferably as thin as possible.

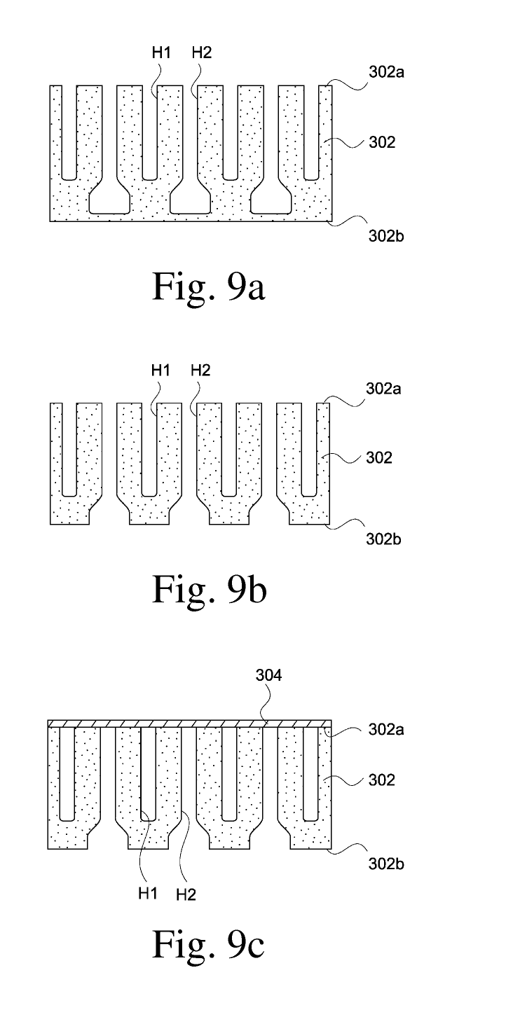

Subsequently, as illustrated in FIG. 9a, the second substrate 303 which is not oxidized may be removed. The removal of the second substrate 303 may be performed by, for example, wet etching.

Subsequently, as illustrated in FIG. 9b, the metal oxide 302 may be removed by a predetermined thickness from the rear surface 302b side. The removal of the metal oxide may be performed by reactive ion etching (RIE). At this time, the metal oxide 302 may be removed by a thickness to such an extent that the holes H2 communicate with the rear surface 302b and the holes H1 do not communicate with the rear surface 302b.

Subsequently, as illustrated in FIG. 9c, the first conductor layer 304 formed of a conductive material may be deposited on the surface 302a. The first conductor layer 304 can be deposited by any method such as a sputtering method or a vacuum deposition method.

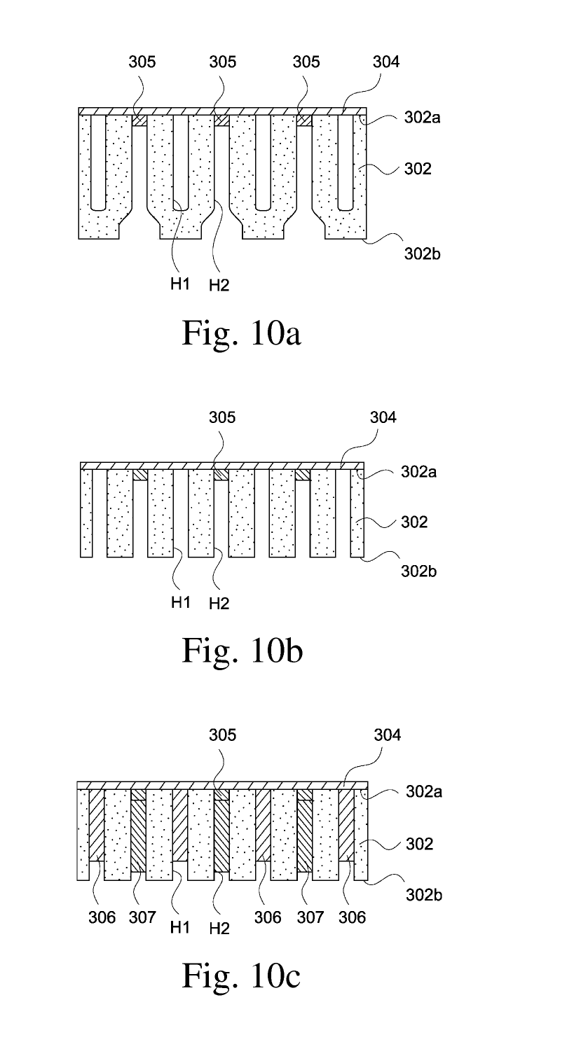

Subsequently, as illustrated in FIG. 10a, a first plating conductor 305 may be embedded in the holes H2. The first plating conductor 305 may be formed of a conductive material, and can be embedded by performing electrolytic plating on the metal oxide 302 using the first conductor layer 304 as a seed layer. Since a plating solution does not enter the holes H1, the first plating conductor 305 may not be formed within the holes H1.

Subsequently, as illustrated in FIG. 10b, the metal oxide 302 may be removed again by a predetermined thickness from the rear surface 302b. The removal of the metal oxide may be performed by reactive ion etching. At this time, the metal oxide 302 may be removed by a thickness to such an extent that the holes H1 communicate with the rear surface 302b.

Subsequently, as illustrated in FIG. 10c, a second plating conductor 306 may be embedded in the holes H1, and a third plating conductor 307 may be embedded in the holes H2. The second plating conductor 306 and the third plating conductor 307 may be formed of a conductive material, and can be embedded by performing electrolytic plating on the metal oxide 302 using the first conductor layer 304 as a seed layer. Meanwhile, according to this manufacturing process, although the second plating conductor 306 and the third plating conductor 307 are formed of the same material, these can also be formed of different materials using other manufacturing processes.

Here, since the first plating conductor 305 is formed in the holes H2 by the previous process, a tip of the third plating conductor 307 may protrude further than a tip of the second plating conductor 306. Hereinafter, the first plating conductor 305 and the third plating conductor 307 will be collectively referred to as a fourth plating conductor 308.

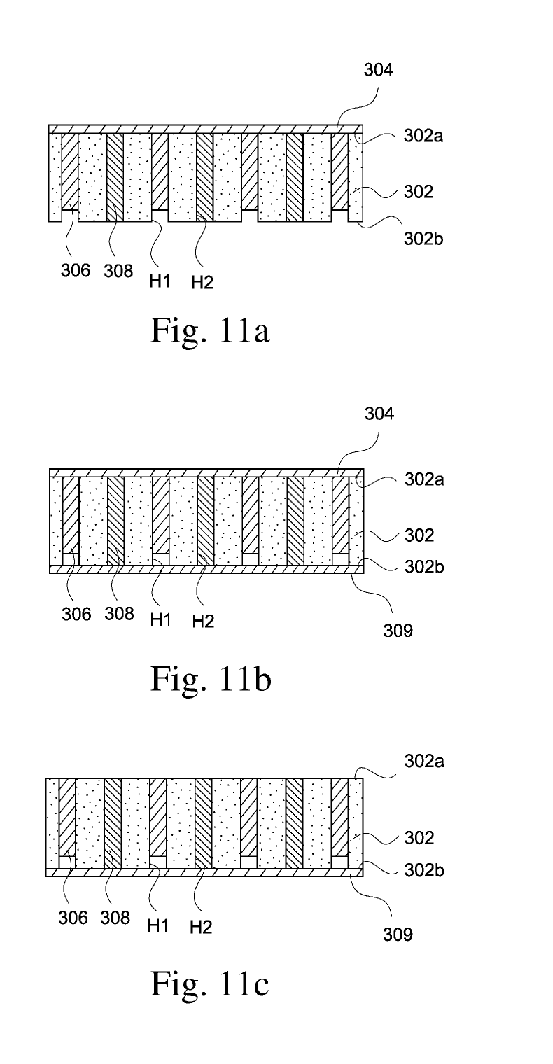

Subsequently, as illustrated in FIG. 11a, the metal oxide 302 may be removed again by a predetermined thickness from the rear surface 302b. The removal of the metal oxide may be performed by chemical mechanical polishing (CMP) or the like. At this time, the metal oxide 302 may be removed by a thickness to such an extent that the fourth plating conductor 308 is exposed by the rear surface 302b and the second plating conductor 306 is not exposed by the rear surface 302b.

Subsequently, as illustrated in FIG. 11b, a second conductor layer 309 formed of a conductive material can be deposited on the rear surface 302b. The second conductor layer 309 may be deposited by any method such as a sputtering method or a vacuum deposition method.

Subsequently, as illustrated in FIG. 11c, the first conductor layer 304 may be removed. The removal of the first conductor layer 304 can be performed by a wet etching method, a dry etching method, an ion milling method, a CMP method, or the like.

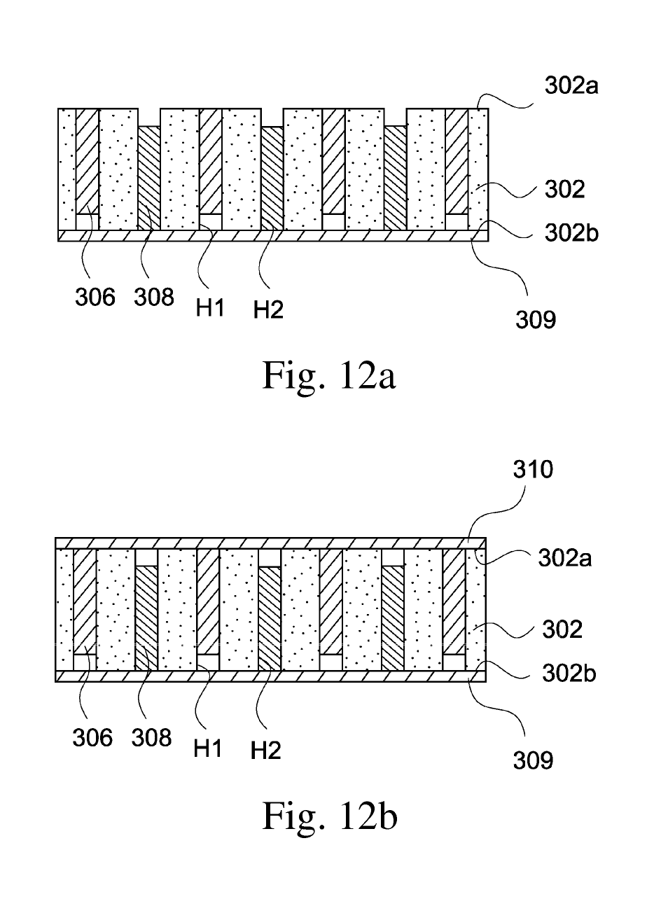

Subsequently, as illustrated in FIG. 12a, electrolytic etching may be performed on the fourth plating conductor 308 using the second conductor layer 309 as a seed layer. Since the fourth plating conductor 308 electrically communicates with the second conductor layer 309, the fourth plating conductor may be etched by electrolytic etching. On the other hand, since the second plating conductor 306 does not electrically communicate with the second conductor layer 309, the second plating conductor may not be etched by electrolytic etching.

Subsequently, as illustrated in FIG. 12b, a third conductor layer 310 formed of a conductive material may be deposited on the surface 302a. The third conductor layer 310 can be deposited by any method such as a sputtering method or a vacuum deposition method.

In the above-described manner, the capacitor 100 can be manufactured. Meanwhile, the metal oxide 302 may correspond to the dielectric layer 101, the third conductor layer 310 may correspond to the first external electrode layer 102, and the second conductor layer 309 may correspond to the second external electrode layer 103. In addition, the second plating conductor 306 may correspond to the first internal electrode 104, and the fourth plating conductor 308 may correspond to the second internal electrode 105.

Meanwhile, the crystallization (heating) process of the metal oxide 302 is performed after the process (FIG. 8a) of opening the holes H. However, the present invention is not limited thereto, and the crystallization process may be performed in other processes. However, when the plating conductor and the conductor layer are already formed, it may be necessary to note that these are not melted.

### [With Regard to Array of Through Holes]

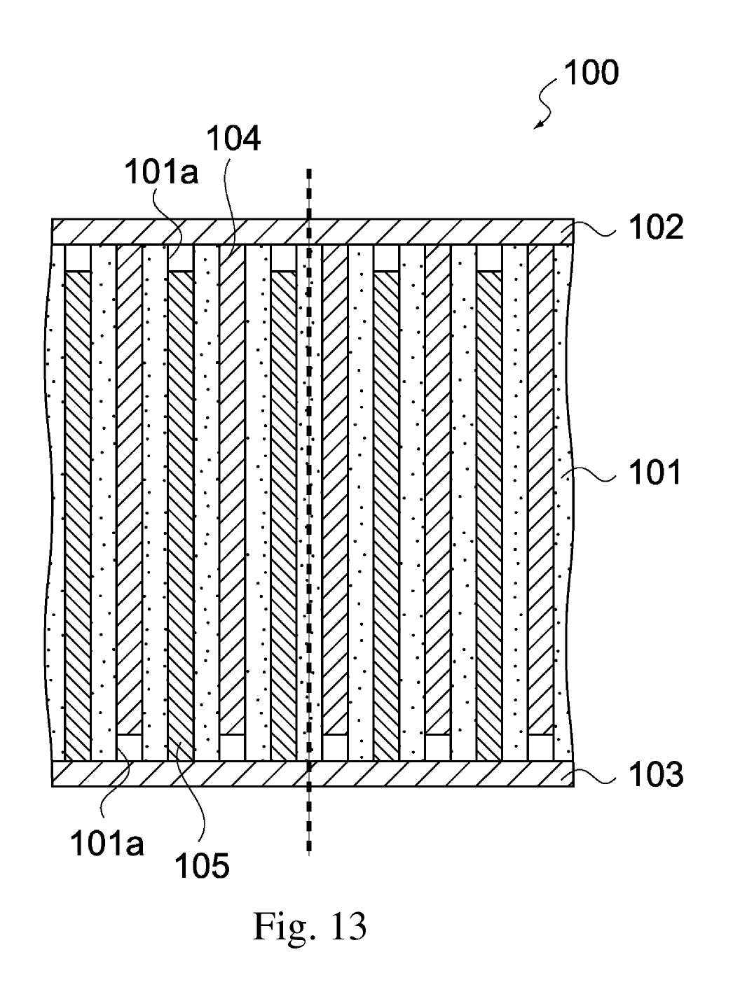

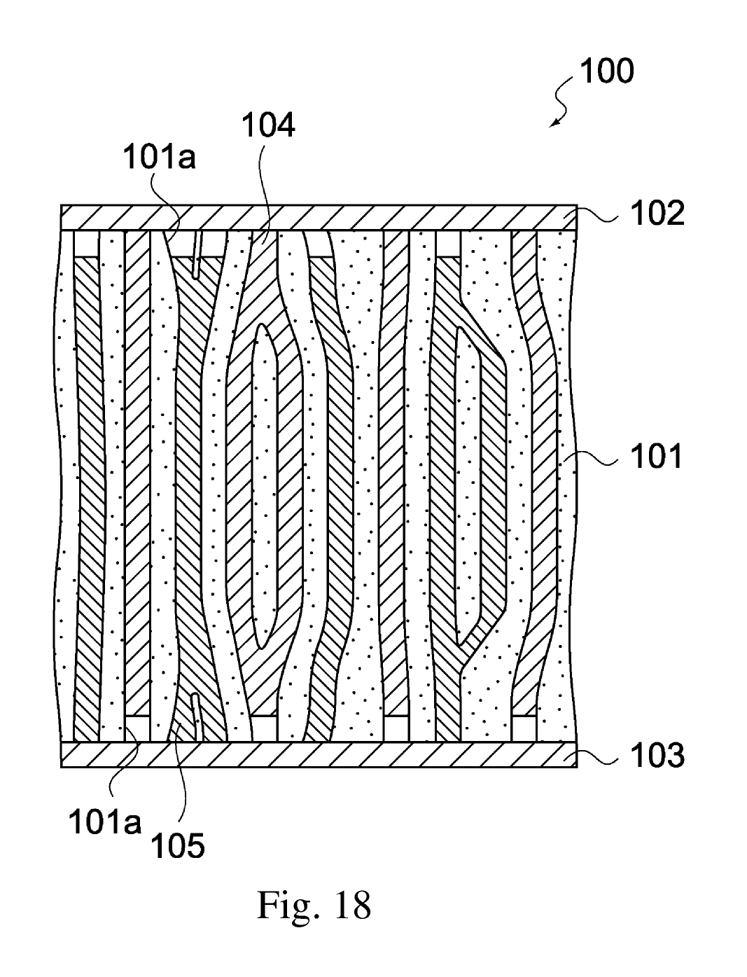

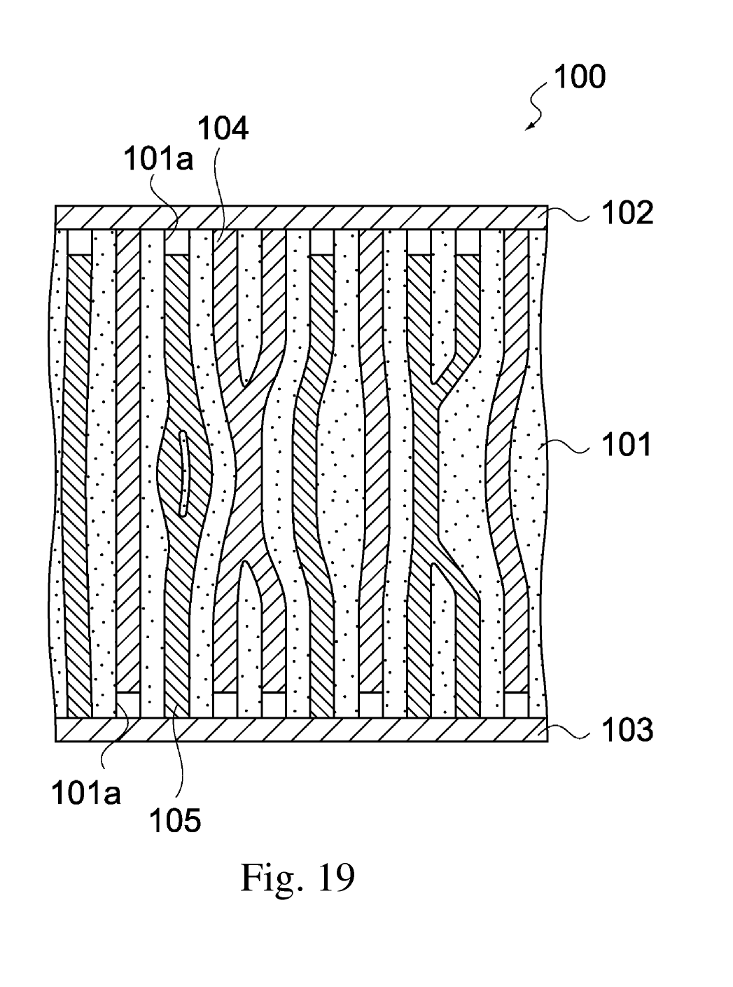

In the above description, the description has been given on the assumption that the through holes 101a (see FIG. 4) which are formed in the dielectric layer 101 are formed along the thickness direction of the dielectric layer 101 and are regularly arrayed. However, the through holes 101a can also be configured so as not to be regularly arrayed as follows. FIGS. 13 to 19 are schematic cross-sectional views of the capacitor 100.

FIG. 13 illustrates the capacitor 100 in which the through holes 101a are arrayed regularly. Since the through holes 101a are arrayed regularly, the first internal electrodes 104 and the second internal electrodes 105 which are formed inside the through holes 101a may be arrayed regularly. In this case, as shown by a dashed line in FIG. 13, cleaving is likely to occur in an extension direction of the through holes 101a (the thickness direction of the dielectric layer 101), and mechanical strength of the capacitor 100 in this direction may become insufficient.

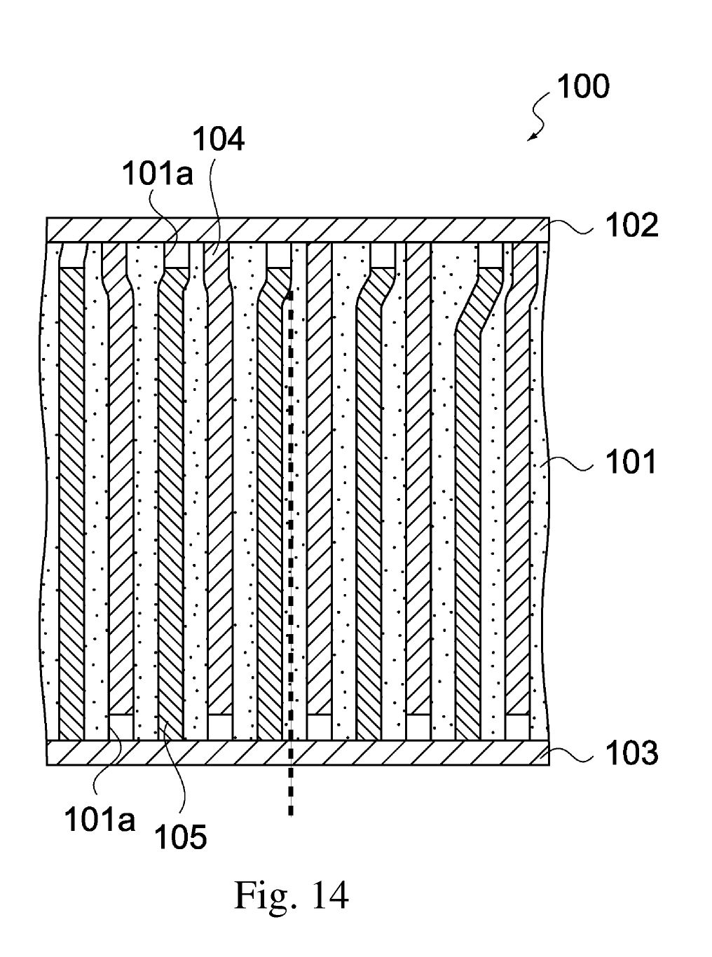

Consequently, as illustrated in FIG. 14, the through holes 101a can be arrayed irregularly in a surface portion of the dielectric layer 101. In this case, the first internal electrodes 104 and the second internal electrodes 105 may be arrayed irregularly along the through holes 101a. As shown by a dashed line in FIG. 14, directions and positions in which cleaving is likely to occur in the thickness direction of the dielectric layer 101 may be different from each other due to the irregular array of the through holes 101a, and thus the mechanical strength of the capacitor 100 in the thickness direction may be increased. Meanwhile, in FIG. 14, although the through holes 101a on the first external electrode layer 102 side are arrayed irregularly, the through holes on the second external electrode layer 103 side may be arrayed irregularly.

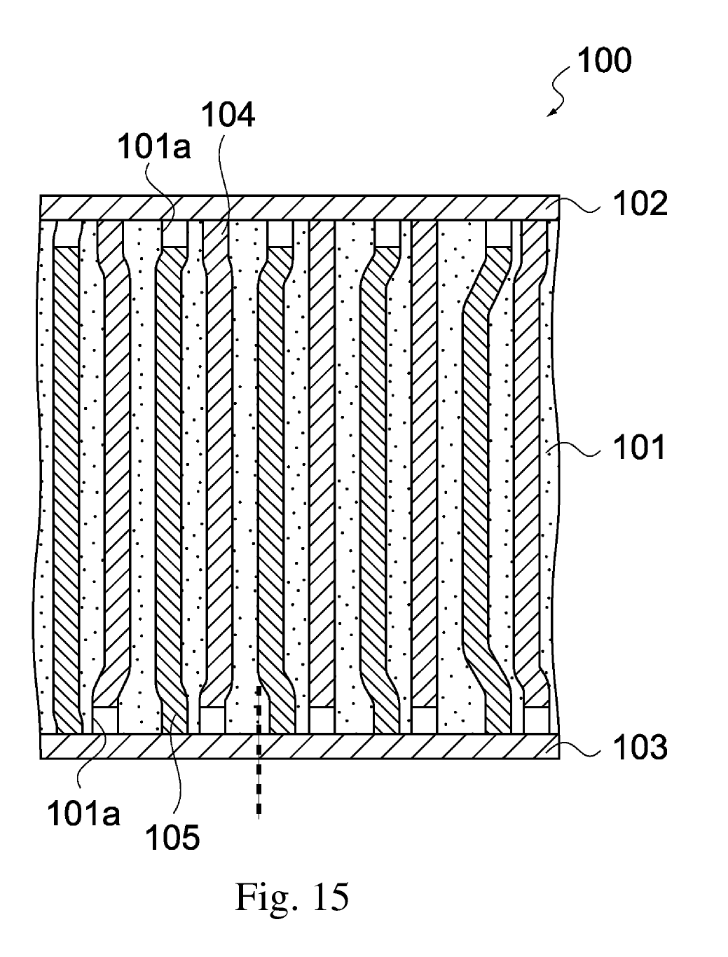

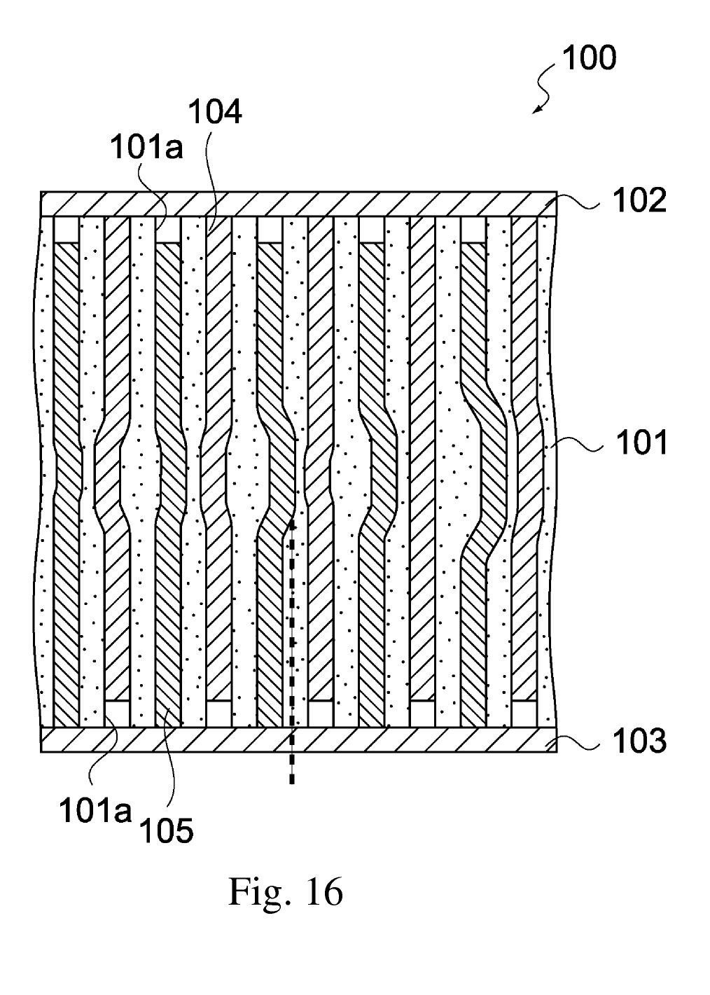

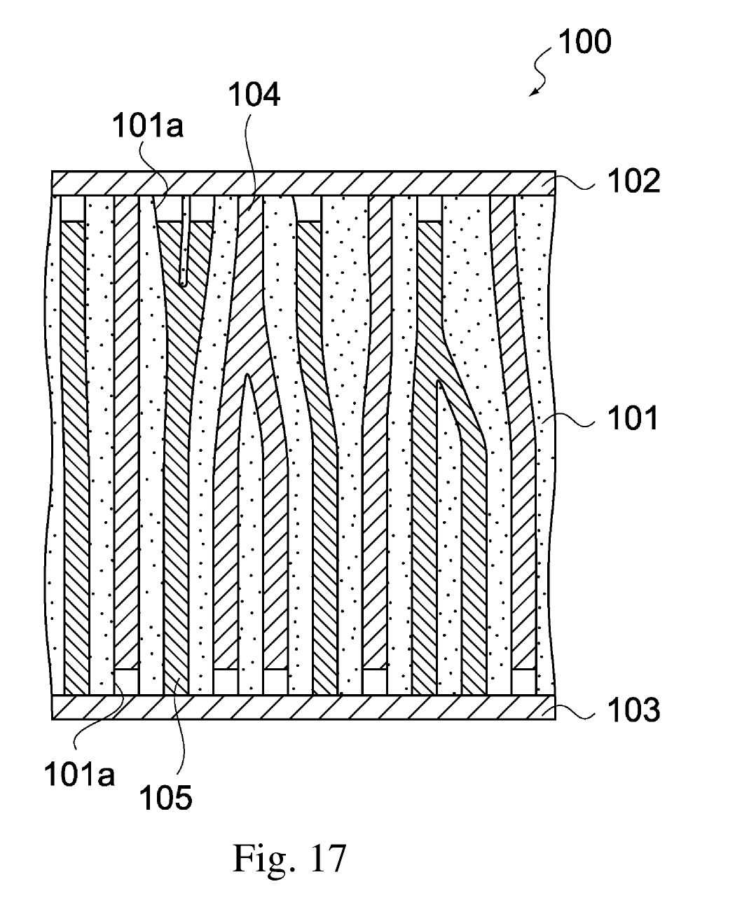

Similarly, the through holes 101a may be arrayed irregularly in surface portions of two sides of the dielectric layer 101 as illustrated in FIG. 15, and the through holes 101a may be arrayed irregularly in a central portion of the dielectric layer 101 as illustrated in FIG. 16. In addition, as illustrated in FIGS. 17 to 19, the through hole 101a may be branched into a plurality of parts in the thickness direction, and the plurality of through holes 101a may be arrayed so as to unite with each other. In any of these cases, directions and positions in which cleaving is likely to occur in the thickness direction of the dielectric layer 101 may be different from each other due to the irregular array of the through holes 101a, and thus the mechanical strength of the capacitor 100 in this direction can be increased.

In order to irregularly array the through holes 101a, conditions (applied voltage or bath solution) of anodization may be adjusted in the above-described anodization process. For example, when the irregular array of the through holes 101a is desired to be formed in only the surface portion of the dielectric layer 101 (FIG. 14), an irregular array may be formed by a process with irregular array conditions from the initialization of the anodization process until a predetermined time, and the rest of regions may be changed to regular array conditions.

Similarly, when an irregular array of the through holes 101a is desired to be formed in surface portions of two sides (FIG. 15) or in a central portion (FIG. 16) of the dielectric layer 101, the irregular array can be realized by changing process conditions at a predetermined timing during the anodization process.

This technique is not limited to the above-described embodiment, and can be appropriately modified without departing from the scope of this technique.

What is claimed is:

1. A capacitor comprising:
a dielectric layer formed of a metal oxide having a crystalline structure and including a first surface, a second surface on the opposite side to the first surface, and a plurality of through holes communicating with the first surface and the second surface;
a first external electrode layer disposed on the first surface;
a second external electrode layer disposed on the second surface;
one or more first internal electrodes formed in the plurality of through holes and connected to the first external electrode layer; and
one or more second internal electrodes formed in the plurality of through holes and connected to the second external electrode layer.

2. The capacitor according to claim 1, wherein the dielectric layer is formed of a material generating through holes by an anodization action.

3. The capacitor according to claim 1, wherein the dielectric layer is formed of an aluminum oxide.

4. The capacitor according to claim 1, wherein the dielectric layer is formed of an aluminum oxide having at least any one crystalline phase of an α phase, a θ phase, a δ phase, and a γ phase.
